(19) United States
(12) Patent Application Publication
(10) Pub. No.: US 2023/0196428 A1
(43) Pub. Date: Jun. 22, 2023

(54) Mobile Marketplace System and Method

(71) Applicant: Lawrence Investment Holdings Ltd, London (GB)

(72) Inventor: Leroy Leonard Lawrence, Berkshire (GB)

(21) Appl. No.: 18/080,511

(22) Filed: Dec. 13, 2022

Related U.S. Application Data
(60) Provisional application No. 63/291,182, filed on Dec. 17, 2021.

(51) Int. Cl. G06Q 30/0601; G06Q 20/32; G06Q 10/083; G06Q 20/38; G06Q 20/40; G06Q 30/0201

(52) U.S. Cl. CPC G06Q 30/0611; G06Q 20/3276; G06Q 30/0641; G06Q 10/083; G06Q 20/381; G06Q 20/40145; G06Q 30/0206

(57) ABSTRACT

A client computing device may scan a quick response (QR) code that may be associated with a physical store location and is physically located at the physical store location. A user of the client computing device may select one or more items that are available for purchase at the physical store location and purchase the one or more items that are available for purchase at the physical store location. A server computing device may receive a purchase request from the client computing device and may execute the purchase using one or more currencies including a currency associated with the user of the client computing device and may select one or more couriers to have the one or more items delivered to a physical address associated with the user of the client computing device.

### CROSS-REFERENCE TO RELATED APPLICATION

This application is related to and claims priority under 35 U.S.C. § 119(e) to U.S. Patent Application No. 63/291,182, filed Dec. 17, 2021, entitled “Mobile Marketplace System and Method,” the entire contents of which are incorporated herein by reference.

### BACKGROUND

Customers such as tourists may visit physical shops during their vacations and desire to make purchases from the physical shops. However, in many locations throughout the world including the United States, the physical shops may be underbanked street market stalls and small shops that sell and offer physical goods. Customers may not be able to purchase the goods because it may be very difficult to find a way to get the goods home. The goods may not fit in a suitcase or may be fragile. In addition, in some other situations, the customers may have a foreign currency or no physical money and are unable to purchase the goods.

It is with these issues in mind, among others, that various aspects of the disclosure were conceived.

### SUMMARY

The present disclosure is directed to a mobile marketplace system and method. The system may include a client computing device that communicates with a server computing device to purchase a product or item at a physical store location. In one example, the client computing device may scan a quick response (QR) code that may be associated with the physical store location and is physically located or posted at the physical store location. The client computing device may send a communication to the server computing device that may include information such as a representation of a particular physical retail location. A user of the client computing device may select one or more items that are available for purchase at the physical store location and purchase the one or more items that are available for purchase at the physical store location.

The server computing device may receive a purchase request from the client computing device and may execute the purchase using one or more currencies including a currency associated with the user of the client computing device and may select one or more couriers to have the one or more items delivered to a physical address associated with the user of the client computing device. The consumer and/or the seller may select the one or more couriers that may be used for the delivery. As an example, the user of the client computing device may scan the QR code in a first country located on one side of the world and have the one or more items delivered to the user's home that may be located in a second country located on another side of the world. In addition, the user may continue to purchase additional items in the future from the physical store location while located in the second country on the other side of the world.

In order to setup the physical store location, a shopkeeper may scan the QR code that is physically located at the physical store location. In addition, the shopkeeper may have to provide biometric information such as an image of a face captured by one or more camera devices of a computing device, a retina captured by one or more sensors of a computing device, and/or a fingerprint captured by one or more sensors of the computing device. The biometric information obtained from the image of the user may be compared with a representation of an identification card and/or from information obtained from a database. The biometric information may be used to confirm an identity of the person and confirm that they are a valid person to establish and/or operate a retail establishment. The shopkeeper may list one or more items for sale by capturing images of each of the items and providing information associated with each of the items such as an item title, an item description, a price or desired price in a currency, among other information. Each image may include metadata such as a location where the image is captured. This location may be compared with a location of the physical store location to ensure that the location in the metadata is within a particular distance from the physical store location.

In one example, a system may include a memory storing computer-readable instructions and at least one processor to execute the instructions to receive an image representing an item to be offered by a particular seller from a particular seller computing device, the image having metadata representing a location of a physical retail storefront associated with the particular seller, determine that the metadata representing the location of the physical retail storefront associated with the particular seller is within a particular distance of an actual location of the physical retail storefront associated with the particular seller, authorize the particular seller to offer the item for sale on a mobile marketplace for purchase, receive a request from a purchaser by a particular purchaser computing device, the request initiated when an imaging device of the particular purchaser computing device captures a unique code associated with the particular seller at the physical retail storefront, transmit information associated with the item to the particular purchaser computing device to be displayed by a graphical user interface (GUI) on a display of the particular purchaser computing device, and receive a purchase request for the item from the particular purchaser computing device and begin a shipment process for the item from the physical retail storefront to a location associated with the purchaser.

In another example, a method may include receiving, by at least one processor, an image representing an item to be offered by a particular seller from a particular seller computing device, the image having metadata representing a location of a physical retail storefront associated with the particular seller, determining, by the at least one processor, that the metadata representing the location of the physical retail storefront associated with the particular seller is within a particular distance of an actual location of the physical retail storefront associated with the particular seller, authorizing, by the at least one processor, the particular seller to offer the item for sale on a mobile marketplace for purchase, receiving, by the at least one processor, a request from a purchaser by a particular purchaser computing device, the request initiated when an imaging device of the particular purchaser computing device captures a unique code associated with the particular seller at the physical retail storefront, transmitting, by the at least one processor, information associated with the item to the particular purchaser computing device to be displayed by a graphical user interface (GUI) on a display of the particular purchaser computing device, and receiving, by the at least one processor, a purchase request for the item from the particular purchaser computing device and beginning a shipment process for the item from the physical retail storefront to a location associated with the purchaser.

In another example, a non-transitory computer-readable storage medium may have instructions stored thereon that, when executed by a computing device cause the computing device to perform operations, the operations including receiving an image representing an item to be offered by a particular seller from a particular seller computing device, the image having metadata representing a location of a physical retail storefront associated with the particular seller, determining that the metadata representing the location of the physical retail storefront associated with the particular seller is within a particular distance of an actual location of the physical retail storefront associated with the particular seller, authorizing the particular seller to offer the item for sale on a mobile marketplace for purchase, receiving a request from a purchaser by a particular purchaser computing device, the request initiated when an imaging device of the particular purchaser computing device captures a unique code associated with the particular seller at the physical retail storefront, transmitting information associated with the item to the particular purchaser computing device to be displayed by a graphical user interface (GUI) on a display of the particular purchaser computing device, and receiving a purchase request for the item from the particular purchaser computing device and beginning a shipment process for the item from the physical retail storefront to a location associated with the purchaser.

These and other aspects, features, and benefits of the present disclosure will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is a block diagram of a mobile marketplace system according to an example of the instant disclosure.

FIG. 2 is another block diagram of the mobile marketplace system according to an example of the instant disclosure.

FIG. 3 is a flowchart of a method of placing one or more items for sale at a particular physical location and allowing the one or more items to be purchased according to an example of the instant disclosure.

FIG. 4 shows a computing device displaying one or more graphical user interfaces associated with a mobile marketplace application according to an example of the instant disclosure.

FIG. 5 shows a seller or operator user interface associated with the mobile marketplace application according to an example of the instant disclosure.

FIG. 6 shows a purchaser or consumer user interface associated with the mobile marketplace application according to an example of the instant disclosure.

FIGS. 7 and 8 show a seller dashboard user interface associated with the mobile marketplace application according to an example of the instant disclosure.

FIG. 9 shows an example of a system for implementing certain aspects of the present technology.

### DETAILED DESCRIPTION

The present invention is more fully described below with reference to the accompanying figures. The following description is exemplary in that several embodiments are described (e.g., by use of the terms “preferably,” “for example,” or “in one embodiment”); however, such should not be viewed as limiting or as setting forth the only embodiments of the present invention, as the invention encompasses other embodiments not specifically recited in this description, including alternatives, modifications, and equivalents within the spirit and scope of the invention. Further, the use of the terms “invention,” “present invention,” “embodiment,” and similar terms throughout the description are used broadly and not intended to mean that the invention requires, or is limited to, any particular aspect being described or that such description is the only manner in which the invention may be made or used. Additionally, the invention may be described in the context of specific applications; however, the invention may be used in a variety of applications not specifically described.

The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail. Any signal arrows in the drawings/figures should be considered only as exemplary, and not limiting, unless otherwise specifically noted. Further, the description is not to be taken in a limiting sense, but is made merely for the purpose of illustrating the general principles of the invention, since the scope of the invention is best defined by the appended claims.

It will be understood that, although the terms “first,” “second,” etc. may be used herein to describe various elements, these elements should not be limited by these terms. These terms are only used to distinguish one element from another. Purely as a non-limiting example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an,” and “the” are intended to include the plural forms as well, unless the context clearly indicates otherwise. It should also be noted that, in some alternative implementations, the functions and/or acts noted may occur out of the order as represented in at least one of the several figures. Purely as a non-limiting example, two figures shown in succession may in fact be executed substantially concurrently or may sometimes be executed in the reverse order, depending upon the functionality and/or acts described or depicted.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Aspects of a mobile marketplace system and method includes a client computing device that communicates with a server computing device to purchase a product or item that may be sold at a particular location such as a physical retail location including an underbanked street market or another location. In one example, the client computing device may scan a QR code that may be located at the physical retail location. The client computing device may send a communication to the server computing device that may include information such as a unique identifier of the physical retail location that is obtained by scanning the QR code. The server computing device may send information associated with one or more products or items that are available for sale at the physical retail location for consumers such as physical products or items. Often times, tourists may limit vacation shopping to what can actually fit into their bags or suitcases. As a result, vacation markets may be unable to sell physical goods to tourists and they do not make recurring sales. In addition, it is very difficult to arrange shipping of the physical goods to the tourists and the cost of the purchase including the shipping is unknown until after the item is purchased. In many cases, the customer is unable to view a price of the physical good and the shipping in their currency.

The client computing device may execute a mobile marketplace application and a user of the client computing device, e.g., a consumer or purchaser, may make real world purchases from often underbanked street market and small shop owners globally. The user may capture a unique code such as a QR code at a retail location and the mobile marketplace application may indicate one or more items that are available for purchase at the retail location. The user of the client computing device may select an item and the mobile marketplace application may provide a real-time price that includes shipping from the retail location to the user's home in the user's currency. As a result, the user may make purchases of items while on vacation and have the items shipped to the user's home. The user may select the one or more items using the mobile marketplace application and add the items to a cart. One or more shipping services may be integrated with the mobile marketplace application and provide the real-time shipping quote to the user. Additionally, after the user returns home, the user can continue to make purchases of physical goods from the retail location and have the items delivered to the user's home. The real-time shipping quote may be based on product weight and/or dimensions of the product or a shipping package, parcel, or box for the product. The real-time shipping quote may not be provided if the product is restricted from international shipping.

In addition, a user of the client computing device, e.g., a seller or operator of a retail location, may list an item or product for purchase by consumers or purchasers by capturing an image or photograph of the item at a particular location associated with the retail location. A seller or operator can list products for purchase when they are verified. Once the seller is verified, they are free to list items. The server computing device may determine whether a location in metadata associated with the image is within a particular distance of an actual location of the retail location. If the location in the metadata is within the particular distance, the server computing device may allow the item or product to be listed. Otherwise, the server computing device may not allow the item or product to be listed.

Consumers may purchase as many items as desired during a vacation or in other situations without being concerned about how the items will be brought home. In addition, the consumers may continue to view and purchase items from the retail location after returning home from vacation.

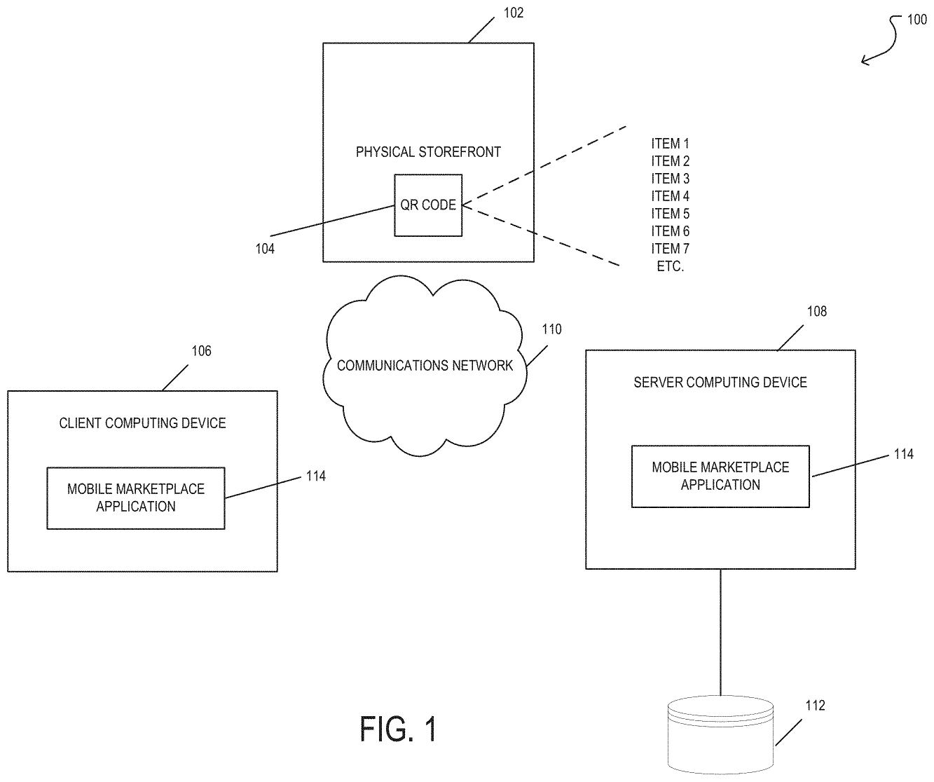

FIG. 1 is a block diagram of a mobile marketplace system 100 according to an example of the instant disclosure. As shown in FIG. 1, the system 100 may include a plurality of physical storefronts 102 such as an underbanked street market or small businesses that may be located in a tourist city or town and may sell items or products such as clothing, jewelry, artwork, and souvenirs, among others. Each physical storefront may have a quick response (QR) code 104 that may be posted or located at the physical storefront that is located in a particular location. The system 100 may further include at least one client computing device 106 and at least one server computing device 108. The at least one server computing device 108 may be in communication with at least one database 112.

The client computing device 106 and the server computing device 108 may have a mobile marketplace application 114 that may be a component of an application and/or service executable by the at least one client computing device 106 and/or the server computing device 108. The mobile marketplace application 114 also may be known as a travel companion application for consumers. For example, the mobile marketplace application 114 may be a single unit of deployable executable code or a plurality of units of deployable executable code. According to one aspect, the mobile marketplace application 114 may include one component that may be a web application, a native application, and/or a mobile application (e.g., an app) downloaded from a digital distribution application platform that allows users to browse and download applications developed with mobile software development kits (SDKs) including the APPLE® iOS App Store and GOOGLE PLAY®, among others.

The mobile marketplace system 100 also may include a relational database management system (RDBMS), e.g., MySQL, or another type of database management system such as a NoSQL database system that stores and communicates data from at least one database 112. The data stored in the at least one database 112 may be associated with the plurality of physical storefronts 102 and items or products that may offered for purchase at each of the physical storefronts and user account or profile information associated with a plurality of users including a plurality of consumers or purchasers that may use the mobile marketplace application 114 and a plurality of sellers that may operate a particular physical storefront 102. Each item may have an associated owner and/or purchaser and be associated with a particular user account. As an example, the database 112 may include one or more tables such as a table associated with the users, a table associated with the physical storefronts, a table associated with the items, and a table associated with the sales, among others.

The at least one client computing device 106 and the at least one server computing device 108 may be configured to receive data from and/or transmit data through a communication network 110. Although the client computing device 106 and the server computing device 108 are shown as a single computing device, it is contemplated each computing device may include multiple computing devices.

The communication network 110 can be the Internet, an intranet, or another wired or wireless communication network. For example, the communication network may include a Mobile Communications (GSM) network, a code division multiple access (CDMA) network, 3^{rd} Generation Partnership Project (GPP) network, an Internet Protocol (IP) network, a wireless application protocol (WAP) network, a WiFi network, a Bluetooth network, a near field communication (NFC) network, a satellite communications network, or an IEEE 802.11 standards network, as well as various communications thereof. Other conventional and/or later developed wired and wireless networks may also be used.

The client computing device 106 may include at least one processor to process data and memory to store data. The processor processes communications, builds communications, retrieves data from memory, and stores data to memory. The processor and the memory are hardware. The memory may include volatile and/or non-volatile memory, e.g., a computer-readable storage medium such as a cache, random access memory (RAM), read only memory (ROM), flash memory, or other memory to store data and/or computer-readable executable instructions. In addition, the client computing device 106 further includes at least one communications interface to transmit and receive communications, messages, and/or signals.

The client computing device 106 could be a programmable logic controller, a programmable controller, a laptop computer, a smartphone, a personal digital assistant, a tablet computer, a standard personal computer, or another processing device. The client computing device 106 may include a display, such as a computer monitor, for displaying data and/or graphical user interfaces. The client computing device 106 may also include a Global Positioning System (GPS) hardware device for determining a particular location, an input device, such as one or more cameras or imaging devices, a keyboard or a pointing device (e.g., a mouse, trackball, pen, or touch screen) to enter data into or interact with graphical and/or other types of user interfaces. In an exemplary embodiment, the display and the input device may be incorporated together as a touch screen of the smartphone or tablet computer.

The server computing device 108 may include at least one processor to process data and memory to store data. The processor processes communications, builds communications, retrieves data from memory, and stores data to memory. The processor and the memory are hardware. The memory may include volatile and/or non-volatile memory, e.g., a computer-readable storage medium such as a cache, random access memory (RAM), read only memory (ROM), flash memory, or other memory to store data and/or computer-readable executable instructions. In addition, the server computing device 108 further includes at least one communications interface to transmit and receive communications, messages, and/or signals.

As an example, the client computing devices 106 and the server computing device 108 communicate data in packets, messages, or other communications using a common protocol, e.g., Hypertext Transfer Protocol (HTTP) and/or Hypertext Transfer Protocol Secure (HTTPS). The one or more computing devices may communicate based on representational state transfer (REST) and/or Simple Object Access Protocol (SOAP). As an example, a first computer (e.g., the client computing device 106) may send a request message that is a REST and/or a SOAP request formatted using Javascript Object Notation (JSON) and/or Extensible Markup Language (XML). In response to the request message, a second computer (e.g., the server computing device 108) may transmit a REST and/or SOAP response formatted using JSON and/or XML.

When users including sellers and consumers first use the mobile marketplace application 114, they can be asked to create an account associated with the mobile marketplace. As an example, a customer may provide account information including name information, an email address, a telephone number, sex information (e.g., male/female), country information, payment method information (e.g., credit/debit card information, PAYPAL information, APPLE PAY information, and GOOGLE PAY information), clothing size information (e.g., S, M, L, size six), shoe size information, basic detail information including a height, weight, and a build type (e.g., slight, medium, stocky), physical address information associated with one or more physical addresses (e.g., home address, business address), and a photograph such as an image of a face, e.g., a selfie. The account information and/or a representation of the account information may be stored in the database 112.

As items are purchased by the consumer, sale information associated with each sale including purchase information, e.g., an item identifier, an item name, an item image, an item title, an item description, retail store information, an item price, and a unique tracking identifier, among others may be stored in the database associated with the consumer account. The consumer may also associate one or more favorite retail locations with their account and one or more favorite items that are available for purchase at retail locations.

Additional information may be associated with the customer account including achievement information including achievement points that may be earned by the customer when using the mobile marketplace application 114. The achievement points may be earned when making purchases, using the mobile marketplace application, referring new users to the application, providing feedback to sellers, connecting with friends, and others. A consumer may invite other users to the application or connect with friends that may already have an account with the application by sending a communication via email, text message, or a notification via the mobile marketplace application 114 to another consumer. The mobile marketplace application 114 may include these gamification features, among others.

When a seller creates an account, the system may perform seller verification to prevent fraud. The seller may be asked to provide account information including business name information (e.g., The Pigee Store), operator name information (e.g., John Doe), an email address, a telephone number, a physical address of a retail store location, a description of the retail store location, hour information for the retail store location for each day of the week, and information associated with items or products for sale. The account information and/or a representation of the account information may be stored in the database 112. As an example, sellers may be prevented or dissuaded from fraud related activities such as replacing a product to be sold with a lower quality product or failing to ship a product when a purchaser leaves the physical premises of the store. The mobile marketplace application 114 may prevent the seller from receiving payment until the product is received by a shipper and tracked as collected. In addition, the mobile marketplace application 114 allows customers to provide public reviews and ratings of shops and sellers. As a result, the mobile marketplace application 114 can confirm the identity of sellers and can inform the appropriate authorities of fraud and/or crime.

As items are sold or purchased, sale information associated with each sale including purchase information, e.g., an item identifier, an item name, an item image, an item title, an item description, item purchaser information, an item price, and a unique tracking identifier, among others may be stored in the database associated with the seller account. Each sale may have one or more tracking identifiers. Each item may have a unique tracking identifier.

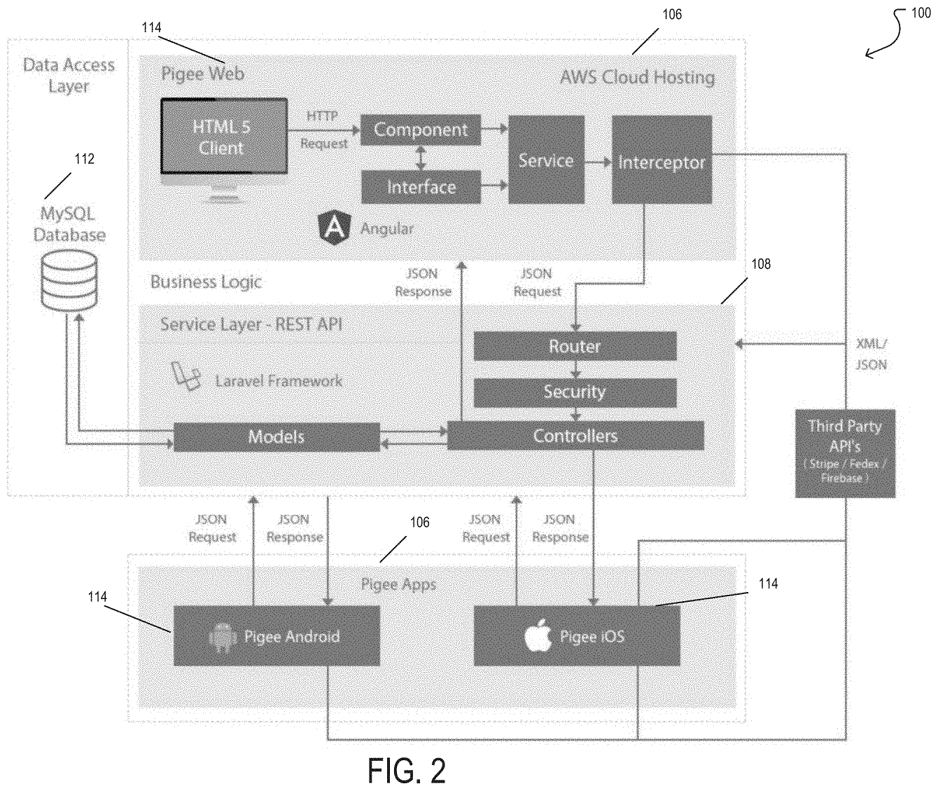

FIG. 2 shows another block diagram of the mobile marketplace system 100 according to an example of the instant disclosure. As shown in FIG. 2, the mobile marketplace application 114 may include native and/or web-based client applications that may be executed by the client computing device 106 including mobile computing devices. The client applications may provide functionality for sellers or operators of physical storefronts to allow the sellers and/or operators to place the one or more products or items for sale as well as view information associated with the physical storefronts including real-time information associated with the one or more products or items for sale as well as historical information including sales information. As shown in FIG. 2, a seller and/or operator using a client computing device 106 may send an HTTP request to view information associated with the physical storefront and the request may be sent as a JSON request to the server computing device 108. The server computing device 108 may receive the JSON request, query the database 112 and return the JSON response to the client computing device 106. The response may be based on information associated with one or more third party application programming interfaces (APIs).

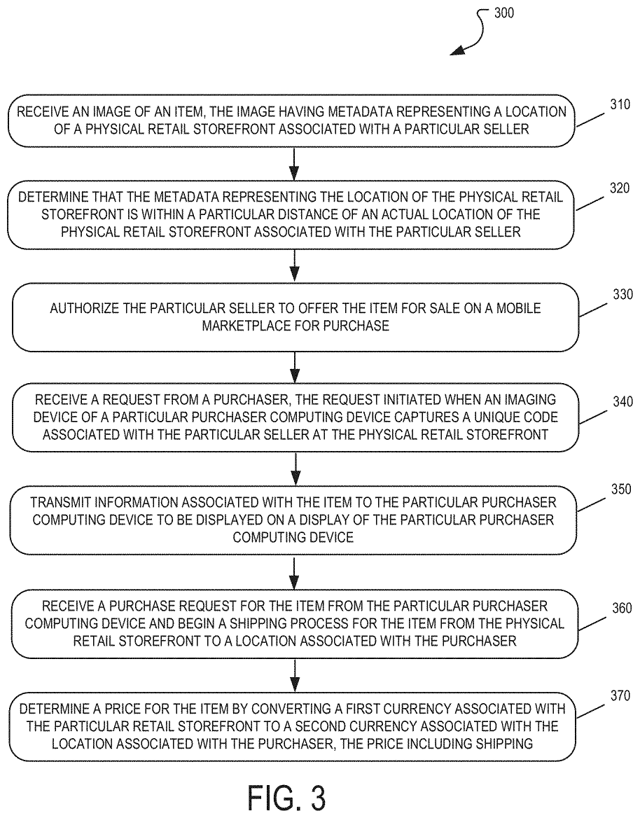

FIG. 3 illustrates an example method 300 of offering one or more items for purchase at a particular physical storefront according to an example of the instant disclosure. Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

According to some examples, the method 300 may include receiving an image representing an item to be offered by a particular seller from a particular seller computing device, the image having metadata representing a location of a physical retail storefront associated with the particular seller at block 310.

Next, according to some examples, the method 300 may include determining that the metadata representing the location of the physical retail storefront associated with the particular seller is within a particular distance of an actual location of the physical retail storefront associated with the particular seller at block 320.

Next, according to some examples, the method 300 may include authorizing the particular seller to offer the item for sale on a mobile marketplace for purchase at block 330. The item may be sold when the location in the metadata is within a particular distance of the actual location of the physical retail storefront.

Next, according to some examples, the method 300 may include receiving a request from a purchaser by a particular purchaser computing device, the request initiated when an imaging device, e.g., one or more cameras, of the particular purchaser computing device captures a unique code associated with the particular seller at the physical retail storefront at block 340. In one example, the unique code can be a quick response (QR) code.

Next, according to some examples, the method 300 may include transmitting information associated with the item to the particular purchaser computing device to be displayed by a graphical user interface (GUI) on a display of the particular purchaser computing device at block 350. The information may be associated with one or more items such as a list of available items and information about each of the items.

Next, according to some examples, the method 300 may include receiving a purchase request for the item from the particular purchaser computing device and beginning a shipment process for the item from the physical retail storefront to a location associated with the purchaser at block 360.

According to some examples, the method 300 may include determining a price for the item by converting a first currency associated with the particular retail storefront to a second currency associated with the location associated with the purchaser at block 370.

The price may include shipping from the particular retail storefront to the location associated with the purchaser. The method 300 may include displaying the price on the GUI on the display of the particular purchaser computing device. The price may include fees that may be associated with a change in currency from the first currency to the second currency as well as tips for the seller that may be optional.

As an example, the particular seller may have to provide two-factor authentication information such as password information, personal identification number (PIN) information, an email address, and/or a telephone number. Additionally, the server computing device 108 may send a one-time-use password or passcode for use by the seller when first setting up the account and/or at other times. The account is to be verified before payments may be accepted. This information may be obtained when the seller creates an account with the mobile marketplace. In some situations, users can provide two-factor authentication information when the metadata indicates that the image of the item was captured at a location that is greater than a particular distance from the physical retail storefront.

According to some examples, the method 300 may include receiving biometric information associated with the particular seller to confirm an identity of the particular seller before the seller may be permitted to offer items for sale on the mobile marketplace. The biometric information may be at least one of facial information, retina information, and fingerprint information, among others.

According to some examples, the method 300 may include determining the price for the item based on real-time sales of the item at the particular retail storefront and adjusting the price for the item based on the real-time sales of the item. The price may be based on machine learning and/or artificial intelligence and may increase and decrease based on purchases made by other consumers as well as a number of items that may be offered for sale by the one or more sellers. If items are not being purchased, the price may be reduced. However, if items are being purchased, the price may increase.

As an example, using historical data, machine learning techniques may be used to provide an artificial intelligence (AI) pricing strategy for items. Machine learning may consider data such as abandoned carts or items, points of abandonment, a location of a seller, a home country of a consumer, and changes in native currency, among others. The AI pricing strategy may continue to grow in complexity as data is collected. Thus, the AI pricing may improve the system's ability to optimize revenue and provide user value. The AI pricing may be used for pricing of shipping, FX handling, as well as seller fees. As a result, the AI pricing may be used to optimize shipping quotes available for the system, sellers, and consumers.

The method 300 may further include sending a follow-up offer to a consumer when the consumer views an item for purchase and decides not to move forward with the purchase process. The follow-up offer may have a price that is less than an initial offered price and/or may have reduced shipping costs.

According to some examples, the method 300 may include determining a location of the particular purchaser computing device and transmitting information associated with at least one physical retail storefront that is within a particular distance of the particular purchaser computing device.

According to some examples, the method 300 may include determining that there is at least one word associated with the information for the item that is not allowed and stopping the purchase request. In one example, this may include disallowing the particular seller to offer the item for sale. The at least one word may be a hot word, or words that may be associated with items that may not be shipped internationally. As an example, hot words may include wine, beer, alcohol, rum, whiskey, vodka, fake, food, mango, fruit, banana, fish, chicken, cocaine, weed, marijuana, tablets, and pills, among others. In some examples, sellers may be prevented from posting these items for sale and/or purchasers may be prevented from purchasing the items if the items are placed on the mobile marketplace for purchase.

According to some examples, images captured by sellers may allow potential purchasers of items to display the items in their homes using augmented reality (AR) to determine whether they will fit in a particular location and so that the user can imagine the item in their space.

According to some examples, the mobile marketplace application 114 may utilize a market aggregator system that may allow competing partners, e.g. couriers and foreign exchange traders or FX aggregators, to provide real-time live offer pricing using an API that communicates with the server computing device 108 in order to allow the partner to compete. The mobile marketplace application 114 may select one or more partners per transaction based on one or more factors including best average pricing for an order, service rating, and a location of the partner that is to service the order. Partners may be able to use the mobile marketplace application 114 to manually update their offer pricing or alternatively they can connect via API to set offer pricing. This may provide competition between partners who may have a better localized offering specific to the order being placed. This competition will lower costs to users. The end pricing shown to the user will be automated and affected by the optimal pricing chosen with the AI and ML discussed above.

According to some examples, consumers may view and provide feedback and rating information about sellers and/or operators on a map graphical user interface. As an example, users may provide comments or rating information about landmarks or shopping areas. When a user selects a shop or landmark available in the map graphical user interface provided by the mobile marketplace application 114, newsfeed items and information may be viewed. Thus, users may view seller/operator information as well as view realtime and real advice and commentary about landmarks or areas. Users may also tag locations, landmarks, and people or other users in commentary provided to the mobile marketplace application 114. Users may be notified by the server computing device 108 when they are tagged and users also may receive mobile marketplace application points for leaving commentary.

According to some examples, users may provide and set landmarks using the map graphical user interface. When naming a landmark, the user can provide city information associated with the landmark. As an example, a map of a city may have shading overlaid on a particular section of the city that may show one or more landmarks in that section. The shading may indicate user provided ratings information associated with the one or more landmarks. When a user selects a landmark using the map graphical user interface, information about the landmark may be provided and/or displayed including one or more photos, posts about the landmark, articles related to the landmark, and information about the area or section of the city associated with the landmark. This information may be used to provide recommendations for tourists. More highly rated areas may attract more commerce and visitors.

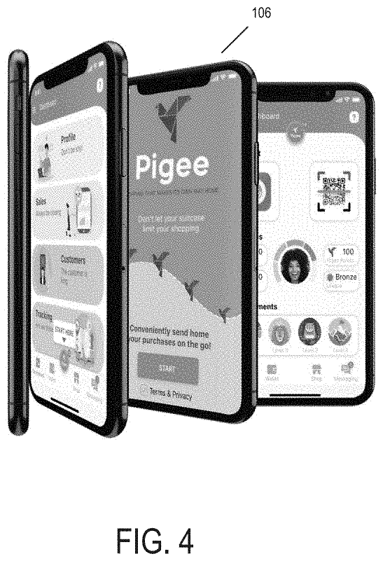

FIG. 4 shows the GUI associated with the mobile marketplace application 114 as displayed on a display of the client computing device 106. As shown in FIG. 4, the client computing device may be a mobile computing device and the mobile marketplace application 114 may be a mobile application executed by the client computing device 106.

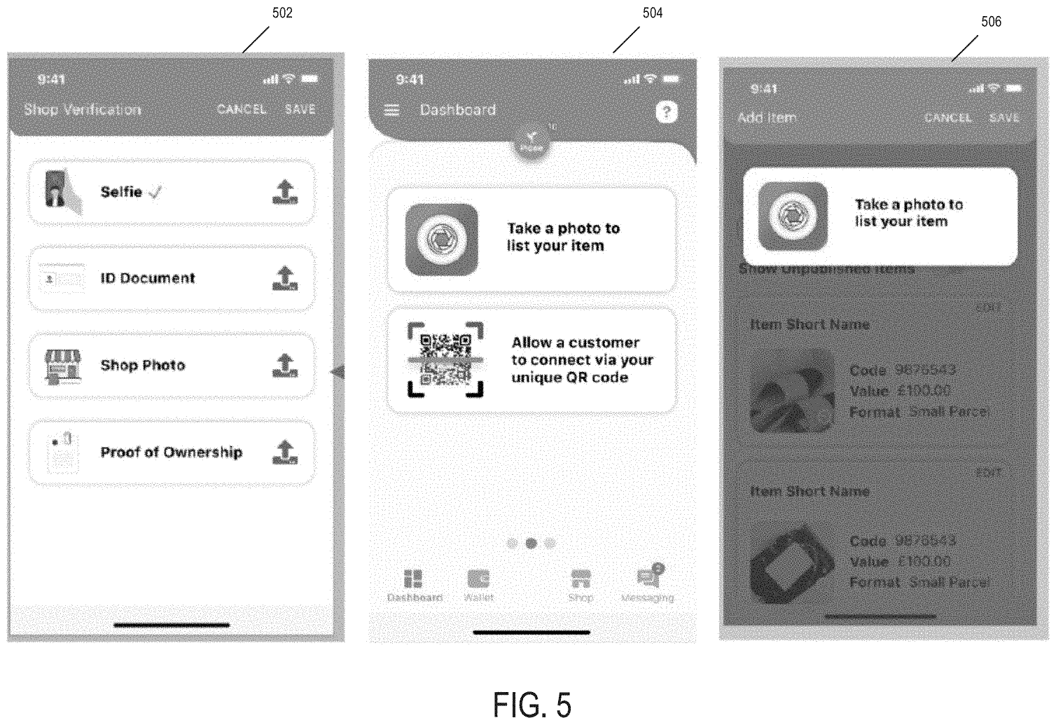

FIG. 5 shows a seller user interface associated with the mobile marketplace application 114 according to an example of the instant disclosure. As shown in FIG. 5, a first screenshot 502 of the GUI may allow a seller to verify their identity by providing one or more forms of identification information including a selfie, image, or photograph that may be captured using the client computing device 106, an identification document, a shop or retail location photograph that may include an interior and/or an exterior of the shop, and/or proof of ownership of the retail location, among others.

FIG. 5 also shows a second screenshot 504 that shows a user interface associated with a seller. The seller may select from a first user interface element or button that may allow the user to take or capture an image or photograph of an item to list the item using the mobile marketplace application 114. In addition, the second user interface element may display the unique code that may allow a customer to connect with the retail establishment and view the one or more items available for purchase. FIG. 5 also shows a third screenshot 506 that illustrates a user interface that may be displayed when the user is capturing an image of an item and/or submitting the item to the mobile marketplace for sale.

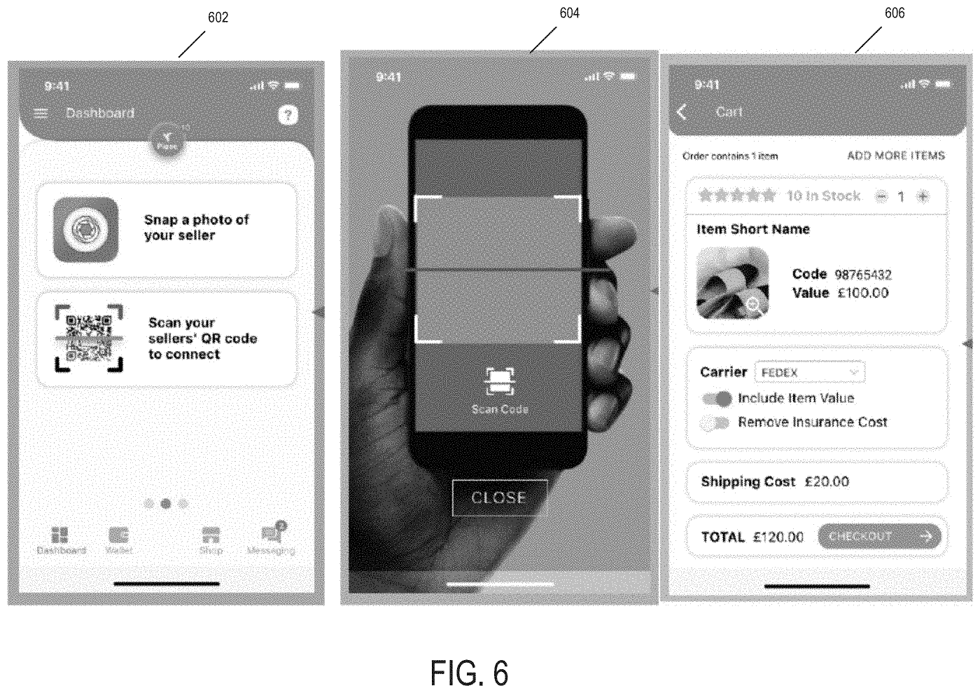

FIG. 6 shows a purchaser or consumer user interface associated with the mobile marketplace application 114 according to an example of the instant disclosure. As shown in FIG. 6, a first screenshot 602 of the GUI shows a user interface element or button that when selected allows the user, e.g., a consumer or purchaser, to capture a unique code such as a QR code 104 that may be found at or located at a physical retail establishment. When the client computing device captures the QR code 104, the client computing device 106 may send a request to the server computing device 108 for information associated with the physical retail establishment. The server computing device 108 may respond to the request and send the information to the client computing device via the mobile marketplace application 114.

FIG. 6 also shows a second screenshot 604 of the GUI that may be displayed by the client computing device 106 when capturing the unique code that may be located at the retail establishment. FIG. 6 also shows a third screenshot 606 that shows the user interface that may be displayed when the user is in the process of purchasing an item available for sale by a seller at the retail establishment. As shown in FIG. 6, the consumer may be purchasing a pair of shoes. The user interface may display an item rating, a number of the items that are in stock, a user interface element such as a button that may allow the user to modify a quantity of the item in the cart, an item short name, an item identifier, e.g., 98765432, a particular value, a carrier for shipping, a real-time shipping cost, and a total for the purchase. In addition, the user interface shows a user interface element such as a button that when selected may begin the transaction and begin the process of having the item shipped from the particular retail location to the user's address.

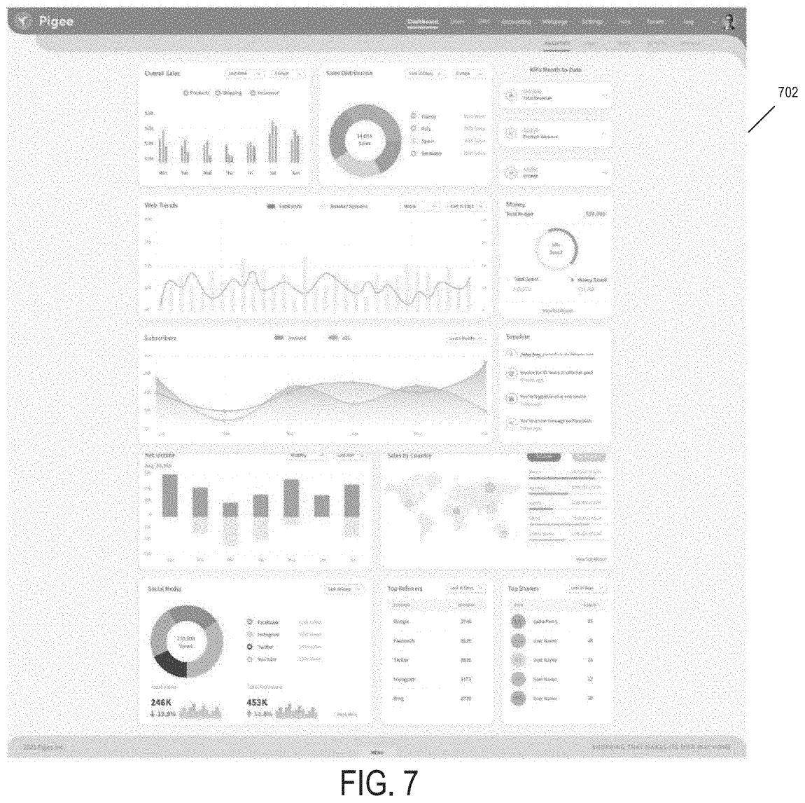

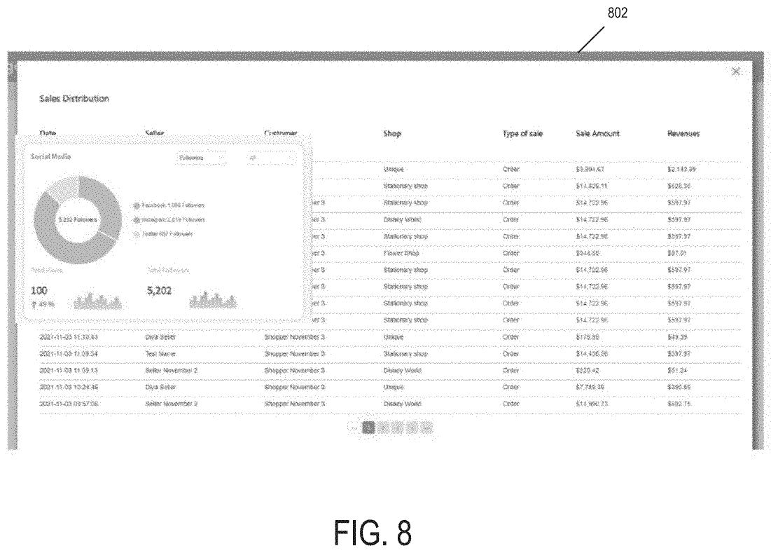

FIGS. 7 and 8 show a seller dashboard associated with the mobile marketplace application 114 according to an example of the instant disclosure. FIG. 7 shows a screenshot 702 that shows an example dashboard that may be displayed by the client computing device 106. In particular, the dashboard may show analytics information that may include one or more sections including overall sales information, sales distribution information, web trend information, subscriber information, net income information, sales by country information, social media information, top referrer information, top sharer information, total revenue information, product revenue information, growth information, money information, and timeline information, among others.

FIG. 8 also shows a screenshot 802 of another view or user interface that may be provided and displayed by the client computing device 106. In particular, the user interface shows sales distribution for one or more sellers as well as social media information. As an example, the sales distribution view shows a number of sales and associated information with each sale information including date information (e.g., 2021-11-03 10:24:46), seller information (e.g., Mr. Seller), customer information (e.g., Mr. Shopper), shop information (e.g., Flower Shop), type of sale information (e.g., Order), sale amount information (e.g., $100.18), and revenue information (e.g., $57.78).

The mobile marketplace application 114 may allow travelers visiting foreign shopping markets to purchase items without worrying whether the items will fit into a suitcase. Sellers may be able to list an item on their account available for sale and purchase and customers may scan a unique code associated with the seller and/or a retail location and select from one or more items provided by the retail location and/or the seller. The customer can select items to be purchased and is provided a price that includes shipping and/or insurance for the items in a particular currency. The customer can choose to pay for the items in cash and/or pay using the mobile marketplace application 114. Upon completion of a sale of the items, the mobile marketplace application 114 provides a unique tracking identifier for the items that can be viewed using the mobile marketplace application. In addition, after returning home, the consumer can continue to purchase items from the retail location and/or the seller using the mobile marketplace application 114.

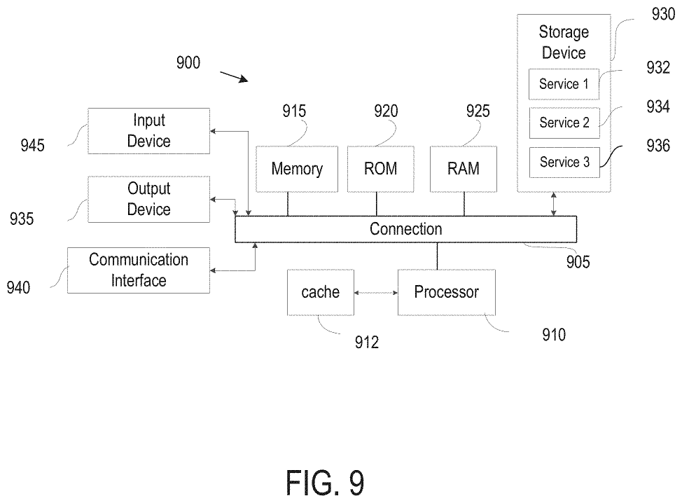

FIG. 9 shows an example of computing system 900, which can be for example any computing device making up the computing device such as the client computing device 106, the server computing device 108, or any component thereof in which the components of the system are in communication with each other using connection 905. Connection 905 can be a physical connection via a bus, or a direct connection into processor 910, such as in a chipset architecture. Connection 905 can also be a virtual connection, networked connection, or logical connection.

In some embodiments, computing system 900 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 900 includes at least one processing unit (CPU or processor) 910 and connection 905 that couples various system components including system memory 915, such as read-only memory (ROM) 920 and random access memory (RAM) 925 to processor 910. Computing system 900 can include a cache of high-speed memory 912 connected directly with, in close proximity to, or integrated as part of processor 910.

Processor 910 can include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms known to those of skill in the art. In some instances, multimodal systems can enable a user to provide multiple types of input/output to communicate with computing system 900. Computing system 900 can include communications interface 940, which can generally govern and manage the user input and system output. There is no restriction on operating on any particular hardware arrangement, and therefore the basic features here may easily be substituted for improved hardware or firmware arrangements as they are developed.

Storage device 930 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 930 can include software services, servers, services, etc., that when the code that defines such software is executed by the processor 910, it causes the system to perform a function. In some embodiments, a hardware service that performs a particular function can include the software component stored in a computer-readable medium in connection with the necessary hardware components, such as processor 910, connection 905, output device 935, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Illustrative examples of the disclosure include:

Aspect 1: A system comprising: a memory storing computer-readable instructions; and at least one processor to execute the instructions to receive an image representing an item to be offered by a particular seller from a particular seller computing device, the image having metadata representing a location of a physical retail storefront associated with the particular seller, determine that the metadata representing the location of the physical retail storefront associated with the particular seller is within a particular distance of an actual location of the physical retail storefront associated with the particular seller, authorize the particular seller to offer the item for sale on a mobile marketplace for purchase, receive a request from a purchaser by a particular purchaser computing device, the request initiated when an imaging device of the particular purchaser computing device captures a unique code associated with the particular seller at the physical retail storefront, transmit information associated with the item to the particular purchaser computing device to be displayed by a graphical user interface (GUI) on a display of the particular purchaser computing device, and receive a purchase request for the item from the particular purchaser computing device and begin a shipment process for the item from the physical retail storefront to a location associated with the purchaser.

Aspect 2: The system of Aspect 1, wherein the unique code comprises a quick response (QR) code.

Aspect 3: The system of Aspects 1 and 2, the at least one processor further to execute the instructions to determine a price for the item by converting a first currency associated with the particular retail storefront to a second currency associated with the location associated with the purchaser, the price including shipping from the particular retail storefront to the location associated with the purchaser and display the price on the GUI on the display of the particular purchaser computing device.

Aspect 4: The system of Aspects 1 to 3, the at least one processor further to execute the instructions to receive biometric information associated with the particular seller to confirm an identity of the particular seller.

Aspect 5: The system of Aspects 1 to 4, wherein the biometric information comprises at least one of facial information, retina information, and fingerprint information.

Aspect 6: The system of Aspects 1 to 5, the at least one processor further to execute the instructions to determine the price for the item based on real-time sales of the item at the particular retail storefront and adjust the price for the item based on the real-time sales of the item.

Aspect 7: The system of Aspects 1 to 6, the at least one processor further to determine a location of the particular purchaser computing device and transmit information associated with at least one physical retail storefront that is within a particular distance of the particular purchaser computing device.

Aspect 8: The system of Aspects 1 to 7, the at least one processor further to execute the instructions to determine that there is at least one word associated with the information for the item that is not allowed and disallow the particular seller to offer the item for sale.

Aspect 9: A method comprising receiving, by at least one processor, an image representing an item to be offered by a particular seller from a particular seller computing device, the image having metadata representing a location of a physical retail storefront associated with the particular seller, determining, by the at least one processor, that the metadata representing the location of the physical retail storefront associated with the particular seller is within a particular distance of an actual location of the physical retail storefront associated with the particular seller, authorizing, by the at least one processor, the particular seller to offer the item for sale on a mobile marketplace for purchase, receiving, by the at least one processor, a request from a purchaser by a particular purchaser computing device, the request initiated when an imaging device of the particular purchaser computing device captures a unique code associated with the particular seller at the physical retail storefront, transmitting, by the at least one processor, information associated with the item to the particular purchaser computing device to be displayed by a graphical user interface (GUI) on a display of the particular purchaser computing device, and receiving, by the at least one processor, a purchase request for the item from the particular purchaser computing device and beginning a shipment process for the item from the physical retail storefront to a location associated with the purchaser.

Aspect 10: The method of Aspect 9, wherein the unique code comprises a quick response (QR) code.

Aspect 11: The method of Aspects 9 and 10, further comprising determining a price for the item by converting a first currency associated with the particular retail storefront to a second currency associated with the location associated with the purchaser, the price including shipping from the particular retail storefront to the location associated with the purchaser and displaying the price on the GUI on the display of the particular purchaser computing device

Aspect 12: The method of Aspects 9 to 11, further comprising receiving biometric information associated with the particular seller to confirm an identity of the particular seller.

Aspect 13: The method of Aspects 9 to 12, wherein the biometric information comprises at least one of facial information, retina information, and fingerprint information.

Aspect 14: The method of Aspects 9 to 13, further comprising determining the price for the item based on real-time sales of the item at the particular retail storefront and adjusting the price for the item based on the real-time sales of the item.

Aspect 15: The method of Aspects 9 to 14, further comprising determining a location of the particular purchaser computing device and transmitting information associated with at least one physical retail storefront that is within a particular distance of the particular purchaser computing device.

Aspect 16: The method of Aspects 9 to 15, further comprising determining that there is at least one word associated with the information for the item that is not allowed and disallowing the particular seller to offer the item for sale.

Aspect 17: A non-transitory computer-readable storage medium, having instructions stored thereon that, when executed by a computing device cause the computing device to perform operations, the operations comprising receiving an image representing an item to be offered by a particular seller from a particular seller computing device, the image having metadata representing a location of a physical retail storefront associated with the particular seller, determining that the metadata representing the location of the physical retail storefront associated with the particular seller is within a particular distance of an actual location of the physical retail storefront associated with the particular seller, authorizing the particular seller to offer the item for sale on a mobile marketplace for purchase, receiving a request from a purchaser by a particular purchaser computing device, the request initiated when an imaging device of the particular purchaser computing device captures a unique code associated with the particular seller at the physical retail storefront, transmitting information associated with the item to the particular purchaser computing device to be displayed by a graphical user interface (GUI) on a display of the particular purchaser computing device, and receiving a purchase request for the item from the particular purchaser computing device and beginning a shipment process for the item from the physical retail storefront to a location associated with the purchaser.

Aspect 18: The non-transitory computer-readable storage medium of Aspect 17, the operations further comprising determining a price for the item by converting a first currency associated with the particular retail storefront to a second currency associated with the location associated with the purchaser, the price including shipping from the particular retail storefront to the location associated with the purchaser and displaying the price on the GUI on the display of the particular purchaser computing device.

Aspect 19: The non-transitory computer-readable storage medium of Aspects 17 and 18, the operations further comprising receiving biometric information associated with the particular seller to confirm an identity of the particular seller.

Aspect 20: The non-transitory computer-readable storage medium of Aspects 17 to 19, wherein the biometric information comprises at least one of facial information, retina information, and fingerprint information.

What is claimed is:

1. A system comprising:
a memory storing computer-readable instructions; and
at least one processor to execute the instructions to:
receive an image representing an item to be offered by a particular seller from a particular seller computing device, the image having metadata representing a location of a physical retail storefront associated with the particular seller;
determine that the metadata representing the location of the physical retail storefront associated with the particular seller is within a particular distance of an actual location of the physical retail storefront associated with the particular seller;
authorize the particular seller to offer the item for sale on a mobile marketplace for purchase;
receive a request from a purchaser by a particular purchaser computing device, the request initiated when an imaging device of the particular purchaser computing device captures a unique code associated with the particular seller at the physical retail storefront;
transmit information associated with the item to the particular purchaser computing device to be displayed by a graphical user interface (GUI) on a display of the particular purchaser computing device; and
receive a purchase request for the item from the particular purchaser computing device and begin a shipment process for the item from the physical retail storefront to a location associated with the purchaser.

2. The system of claim 1, wherein the unique code comprises a quick response (QR) code.

3. The system of claim 1, the at least one processor further to execute the instructions to determine a price for the item by converting a first currency associated with the particular retail storefront to a second currency associated with the location associated with the purchaser, the price including shipping from the particular retail storefront to the location associated with the purchaser and display the price on the GUI on the display of the particular purchaser computing device.

4. The system of claim 1, the at least one processor further to execute the instructions to receive biometric information associated with the particular seller to confirm an identity of the particular seller.

5. The system of claim 4, wherein the biometric information comprises at least one of facial information, retina information, and fingerprint information.

6. The system of claim 1, the at least one processor further to execute the instructions to determine the price for the item based on real-time sales of the item at the particular retail storefront and adjust the price for the item based on the real-time sales of the item.

7. The system of claim 1, the at least one processor further to determine a location of the particular purchaser computing device and transmit information associated with at least one physical retail storefront that is within a particular distance of the particular purchaser computing device.

8. The system of claim 1, the at least one processor further to execute the instructions to determine that there is at least one word associated with the information for the item that is not allowed and disallow the particular seller to offer the item for sale.

9. A method, comprising:
receiving, by at least one processor, an image representing an item to be offered by a particular seller from a particular seller computing device, the image having metadata representing a location of a physical retail storefront associated with the particular seller;
determining, by the at least one processor, that the metadata representing the location of the physical retail storefront associated with the particular seller is within a particular distance of an actual location of the physical retail storefront associated with the particular seller;
authorizing, by the at least one processor, the particular seller to offer the item for sale on a mobile marketplace for purchase;
receiving, by the at least one processor, a request from a purchaser by a particular purchaser computing device, the request initiated when an imaging device of the particular purchaser computing device captures a unique code associated with the particular seller at the physical retail storefront;
transmitting, by the at least one processor, information associated with the item to the particular purchaser computing device to be displayed by a graphical user interface (GUI) on a display of the particular purchaser computing device; and
receiving, by the at least one processor, a purchase request for the item from the particular purchaser computing device and beginning a shipment process for the item from the physical retail storefront to a location associated with the purchaser.

10. The method of claim 9, wherein the unique code comprises a quick response (QR) code.

11. The method of claim 9, further comprising determining a price for the item by converting a first currency associated with the particular retail storefront to a second currency associated with the location associated with the purchaser, the price including shipping from the particular retail storefront to the location associated with the purchaser and displaying the price on the GUI on the display of the particular purchaser computing device.

12. The method of claim 9, further comprising receiving biometric information associated with the particular seller to confirm an identity of the particular seller.

13. The method of claim 12, wherein the biometric information comprises at least one of facial information, retina information, and fingerprint information.

14. The method of claim 9, further comprising determining the price for the item based on real-time sales of the item at the particular retail storefront and adjusting the price for the item based on the real-time sales of the item.

15. The method of claim 9, further comprising determining a location of the particular purchaser computing device and transmitting information associated with at least one physical retail storefront that is within a particular distance of the particular purchaser computing device.

16. The method of claim 9, further comprising determining that there is at least one word associated with the information for the item that is not allowed and disallowing the particular seller to offer the item for sale.

17. A non-transitory computer-readable storage medium, having instructions stored thereon that, when executed by a computing device cause the computing device to perform operations, the operations comprising:
receiving an image representing an item to be offered by a particular seller from a particular seller computing device, the image having metadata representing a location of a physical retail storefront associated with the particular seller;
determining that the metadata representing the location of the physical retail storefront associated with the particular seller is within a particular distance of an actual location of the physical retail storefront associated with the particular seller;
authorizing the particular seller to offer the item for sale on a mobile marketplace for purchase;
receiving a request from a purchaser by a particular purchaser computing device, the request initiated when an imaging device of the particular purchaser computing device captures a unique code associated with the particular seller at the physical retail storefront;
transmitting information associated with the item to the particular purchaser computing device to be displayed by a graphical user interface (GUI) on a display of the particular purchaser computing device; and
receiving a purchase request for the item from the particular purchaser computing device and beginning a shipment process for the item from the physical retail storefront to a location associated with the purchaser.

18. The non-transitory computer-readable medium of claim 17, the operations further comprising determining a price for the item by converting a first currency associated with the particular retail storefront to a second currency associated with the location associated with the purchaser, the price including shipping from the particular retail storefront to the location associated with the purchaser and displaying the price on the GUI on the display of the particular purchaser computing device.

19. The non-transitory computer-readable medium of claim 17, the operations further comprising receiving biometric information associated with the particular seller to confirm an identity of the particular seller.

20. The non-transitory computer-readable medium of claim 19, wherein the biometric information comprises at least one of facial information, retina information, and fingerprint information.
